(19) United States
(12) Patent Application Publication
(10) Pub. No.: US 2002/0165895 A1
(43) Pub. Date: Nov. 7, 2002

(54) Algorithm for determining piece-wise homogeneity of data

(75) Inventors: John E. Arwe, Poughkeepsie, NY (US); Juergen M. Holtz, Pleidelsheim (DE)

Correspondence Address: CANTOR COLBURN, LLP, 55 GRIFFIN ROAD SOUTH, BLOOMFIELD, CT, 06002

(73) Assignee: International Business Machines, Armonk, NY (US)

(21) Appl. No.: 09/791,423

(22) Filed: Feb. 23, 2001

(51) Int. Cl. G06F 9/00

(52) U.S. Cl. 709/102; 709/104; 709/105

(57) ABSTRACT

A method and apparatus to determine the piece-wise homogeneity of data, i.e., whether the data of a set Ry consists entirely of data from a single set Sz over a period of time. In operation, for each set of data in a service class Sz, the identity of the last source and a unique “signature” which changes each time the source changes is recorded. This information is provided along with the existing data to the data consumers. Each data consumer can then determine homogeneity by comparing the ending signature with the starting signature for any interval. If the data is homogeneous, the signature is the same, and subdivisions applicable to set Sz are applicable to Ry. In another embodiment, a data provider makes observations at regularly scheduled intervals, in an interval mode of operation rather than providing data in total mode.

### BACKGROUND OF THE INVENTION

The present invention relates to computer software and has application in operating system workload management. In particular, the present invention relates to a method and apparatus for determining whether a specific relationship exists between subsets of a body of aggregated data.

A common need that arises in almost any endeavor is verification that some desired result is achieved. To this end, critical values are often collected throughout the endeavor in order to characterize the behavior or state of inputs, outputs, and the process transforming the inputs into outputs. The choice of which values are critical is specific to the application of interest, as are methods for collecting and presenting the data. Often endeavors are repeated, and it is desirable to compare the critical values over time as these repetitions occur. The comparison itself may occur in real time (while a repetition occurs) or at a later time (comparison to historical data), using either individual endeavors or collections of them. Each set of critical values observed during an endeavor is a data observation.

One example of such an endeavor is performing tasks on a computing system. Each task processed in a computing system consumes some amount of a number of distinct resources, such as CPU, storage, and I/O bandwidth. The observed usage of a computing task or an aggregation of such tasks may be used to improve the computing system (allowing the same tasks to be done with fewer resources), to improve the task itself (accomplishing the same useful result using less resources), and/or to recover the costs of the computing system (billing individuals or organizations for the resources they consume), among other things.

In single-purpose monolithic systems, the relevant data can be instrumented, collected, and reported in any way that the users require, is physically possible, and that the users are willing to pay for, because one has access to each data observation (set of values recorded at a point in time). In larger and general purpose systems, there may be several different levels of abstraction at which measurement and reporting occurs. For pragmatic purposes, these more complex systems are often constructed of parts which are intended to operate in a largely independent fashion while still cooperating to achieve the system's purposes. General-purpose interfaces are typically defined in order to reduce the dependencies between parts at different levels of abstraction, and between parts performing distinct functions at similar levels of abstraction. Usually, but not always, multiple data observations are aggregated according to one or more criteria and only the combined “logical observation” is visible to higher levels of abstraction. However, the basic need to report data remains; the addition of interfaces merely allows the separation of data provider and data consumer into distinct entities.

There are two basic designs for this type of general-purpose data provider interface: either data is provided at specific, regular intervals as deltas (the value, for example CPU consumption, that occurred only during a single interval), or data is provided as totals (for example, total CPU consumed since reporting started). Consumers of total mode data are free to process it as they see fit, including calculating deltas whose interval length is arbitrary by subtracting any two total mode snapshots of data. Compositions of these are possible, e.g. combining two reported interval deltas to create the values for a single logical interval twice as long in duration, but they do not change the underlying delta/total dichotomy.

There are advantages, in a general-purpose system, for total mode reporting. The most important advantage of total mode reporting is that it does not restrict all users of the interface to work with some multiple of the same (data provider's) interval. There can be multiple data consumers, each querying the data provider at independent intervals, with no interference between the provider and consumer(s) nor amongst the various consumer(s).

In contrast, a data provider which provides deltas forces all consumers to work with data in intervals that are integral multiples of the data provider's interval. If the data provider provides one set of data every 15 minutes, no consumer can use that data provider to examine smaller intervals (e.g. 5 minutes) or intervals greater than 15 minutes but not a multiple of 15 (e.g. 20) without making baseless assumptions about the data (e.g. linearity). Furthermore, it may be burdensome to examine intervals much greater than the data provider's chosen interval. If the data provider provides a set of data every 6 seconds, 600 sets of calculations must be made by the consumer to determine the delta for each hour.

In the most common case where individual observations at the lowest level of granularity are hidden by the data provider, individual data observations collected by the data provider are aggregated into collections based on some criteria, and only these combined “logical observations” are available to the data consumers. This is the same principle used to create stock indices from the prices of individual stocks. The stock index is a logical observation based on a group of individual stock prices.

Logical observations can be created using whatever criteria the data provider allows. The criteria values associated with each logical observation act as metadata, providing additional information about the “interesting” data in the logical observation.

This can be further explained by way of analogy with reference to FIG. 1. In the case where application of interest is retailing, each purchase constitutes an observation 12 visible to the Accounting department, which is the data provider 15 in this analogy. Each purchase also has several attributes: amount, date, item, retailer, supplier, and so on. Accounting combines these observations based on certain criteria to produce several reports, or logical observations 22, for management: purchases by retailer and purchases by supplier.

The suppliers, who are the data consumers 25, do not want to see every purchase. Instead, they want a summary of purchases divided into expensive, average, and cheap items (high, medium, and low cost). Since the suppliers cannot agree on the boundaries between categories, each supplier has its own threshold values. So Accounting (the data provider 15) creates reports (logical observations 22) to a supplier (data consumer 25) whenever one is requested. The reports (logical observations 22) contain the total amount and number of items purchased in each category (expensive, average, cheap), for each supplier.

Since the amount of space used for data storage is a concern, Accounting does not keep the individual receipts. It maintains only the summary data (logical observations), and in fact maintains only the current running total. Each supplier gets a report at whatever frequency it desires, simply by asking Accounting for a current report. The supplier then subtracts the beginning-of-period totals from the end-of-period totals, yielding the interval totals. If the supplier does this monthly, it can also create an annual report either by adding up the previous twelve monthly summaries or by subtracting the previous year's December report totals from the current year's December report totals.

There is no reason to restrict the data provider to reporting logical observations grouped according to only on a single criterion. Often there are two or more axes along which the data could usefully be segregated. In the example cited, an additional set of reports is produced that contains the same data segregated by retailer rather than supplier. Note that different sets of logical observations 22, which contain data for the same interval but are grouped according to different criteria, can be correlated to yield additional useful information when the data has certain characteristics. Formally, if a set of logical observations grouped according to criterion R all share the same values for a second useful criterion S, and S has subcategories, then those subcategories apply to R as well. In the example cited: if all items purchased by a retailer R were supplied by supplier S, then S's thresholds for cheap/average/expensive apply to R. This is true even though the data provider 15 did not guarantee that all sales by S were to R. This idea holds over arbitrary intervals as well. If a retailer R only purchased from a supplier S during some interval, the supplier S's thresholds for cheap/average/expensive apply to R during that interval. Showing R's data subdivided into cheap/medium/expensive using S's thresholds could tell R how many cheap items it purchased and (using S's thresholds) what the cost range of those purchases was. Had R instead purchased from multiple suppliers Sl . . . Sm with different thresholds during the interval, R would in general not be able to determine anything about the number of purchases within a given price range.

This general structure of data being reported based on what amounts to different sort keys (R and S) arises in the workload management of computing systems. The resources consumed in accomplishing tasks (T1, T2, . . . ) are often reported in aggregated form, with tasks being grouped together in service classes (S1, S2, . . . ) based on varying, usually independent, criteria. These groups are commonly subdivided (Sll, Slm, Slh) based on criteria such as low/medium/high resource usage, where the thresholds differentiating low from medium and high are specific to the type of task (its service class) being performed. The same tasks (T1, T2, . . . ) are also associated with other groups, i.e., report classes (R1, R2 , . . . ) according to other criteria but no subcategorization of Rs is provided. Applying the same subcategorization to Rs would incur significant management overhead. The term “service class” simply means a grouping of subcategorized data having a common attribute. The term “report class” simply means a different grouping of data.

A particular example of this structure has existed in the assignee's MVS® operating system since performance groups were introduced, without solution. The problem's impact was minimized by creating additional instances of S so that the subcategory data was available directly. With MVS®5.1.0 (1994) this bypass impaired Workload Management (WLM)'s ability to manage the computing system effectively.

### SUMMARY

The above discussed and other drawbacks and deficiencies of the prior art are overcome or alleviated by a method and apparatus for determining piece-wise homogeneity of data, i.e., whether the data of a set Ry consists entirely of data from a single set Sz over a period of time. In operation, for each set of data in a service class Sz, the identity of the last source and a unique “signature” which changes each time the source changes is recorded. This information is provided along with the existing data to the reporting products. Each recipient can then determine homogeneity by comparing the ending signature with the starting signature for any interval. If the signature is the same, the data is homogeneous, and subdivisions applicable to set Sz are applicable to Ry. These operations can be performed independently over different intervals, so that a change in identity of S between consecutive intervals still results in two homogeneous sets of data. For example, if Ry contains only data from Sz during interval n, and only data from Sx during interval n+1, then Ry is homogeneous with Sz during interval n and homogeneous with Sx during interval n+1, but is heterogeneous during the combined interval.

In another embodiment, a data provider makes observations at regularly scheduled intervals, in an interval mode of operation rather than providing data in total mode.

### BRIEF DESCRIPTION OF THE DRAWINGS

Referring to the exemplary drawings wherein like elements are numbered alike in the several FIGURES:

FIG. 1 shows a data reporting structure by way of analogy;

FIG. 2 illustrates homogeneous and heterogeneous classes;

FIG. 3 shows a chart illustrating periods;

FIG. 4 shows data buckets illustrating piece-wise homogeneity of data;

FIG. 5 shows a flowchart illustrating a data provider process; and

FIG. 6 shows a flowchart illustrating a data consumer process.

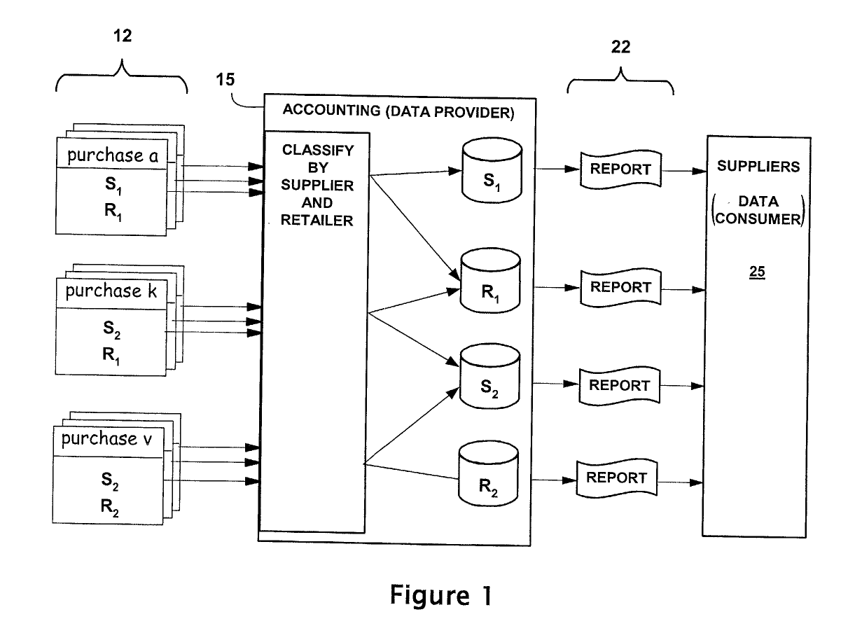

### DETAILED DESCRIPTION OF THE PREFERRED EMBODIMENTS

Workload management (WLM) is a concept whereby units of work (processes, threads, etc.) that are managed by an operating system are organized into classes (service classes) for purposes of resource allocation. Each service class can be further divided into periods, based upon criteria (such as the amount of resources consumed by a unit of work) specific to the service class. The same units of work can also be organized into other classes (report classes) according to any other arbitrary need (such as along the organizational boundaries of the owners of the units of work). Report classes are also divided into periods, based on the criteria from the service class to which the unit of work is assigned. Data about the observed behavior of these units of work (resource consumption, response time, etc.) can be collected as the work executes and recorded for later analysis.

Workload managers of this general type are disclosed in the following commonly owned patents, pending patent applications and non-patent publications, incorporated herein by reference:

U.S. Pat. No. 5,504,894 to D. F. Ferguson et al., entitled “Workload Manager for Achieving Transaction Class Response Time Goals in a Multiprocessing System”;

U.S. Pat. No. 5,473,773 to J. D. Aman et al., entitled “Apparatus and Method for Managing a Data Processing System Workload According to Two or More Distinct Processing Goals”;

U.S. Pat. No. 5,675,739, to C. K. Eilert et al., entitled “Apparatus and Method for Managing a Distributed Data Processing System Workload According to a Plurality of Distinct Processing Goal Types”;

OS/390 MVS Planning: Workload Management, IBM publication GC28-1761-13, 2000;

OS/390 MVS Programming: Workload Management Services, IBM publication GC28-1773-08, 2000. Of the patents and applications, U.S. Pat. Nos. 5,504,894 and 5,473,773 disclose basic workload management systems; U.S. Pat. No. 5,675,739 discloses particular applications of the workload management system of U.S. Pat. No. 5,437,773. The two non-patent publications describe an implementation of workload management in the IBM®z/ OS® (formerly OS/390® and MVS®) operating system.

In an exemplary computing system, each task that is processed consumes some amount of a number of distinct resources, such as CPU, storage, and I/O bandwidth. The observed usage of a computing task or an aggregation of such tasks is reported for purposes of, among other things, improving the computing system, i.e., allowing the same tasks to be done with fewer resources; improving the task itself such as by accomplishing the same useful result using less resources; and/or to recover the costs of the computing system, e.g., for billing.

Each task to be reported has a number of characteristics, by which the task may be sorted or classified as members of various sets. The computing system maintains totals for each set but does not maintain records of each task individually. In a first embodiment, the computing system operates in total mode, reporting the totals accumulated in each set, while in a second embodiment, the computing system operates in delta mode, and reports only the totals that accumulated during the previous completed selected interval of time.

Among other things, each task is a member of one of a number of service classes S and is a member of one of a number of report classes R. In addition, the task is assigned to one of several subsets, e.g., periods, of each service class Sy, wherein the thresholds between the several subsets varies from one service class Sy to another.

When all of the data in a report class Rx came from one or more tasks also in service class Sy, then any property satisfied by a subcategory of Sy is also satisfied by the corresponding subcategory of Rx. For example, the period thresholds of Sy can be meaningfully applied to Rx as well; otherwise they cannot (ignoring the case where the thresholds are identical), since thresholds from both Sy and another service class Sz would have been used to divide the data into periods. The first case is called homogeneous, and the second case heterogeneous. Data in Rx that is homogeneous contains data from only one Sy; data in Rx that contains data from more than one S (Sy, Sz , . . . ) is heterogeneous.

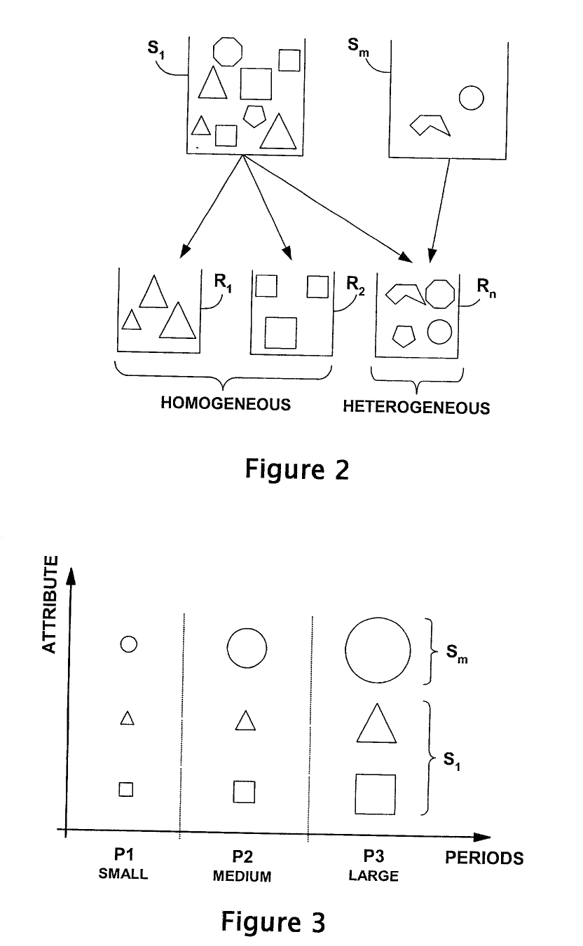

This can be illustrated by reference to FIG. 2, wherein each task is substituted with an item having various characteristics. The apparatus organizes a potentially large number of these items into a much smaller number of service classes Sl to Sm and report classes Rl to Rn. Each item is associated with a service class based on a set of its attributes Al-Ap according to some set of characteristic attributes. In FIG. 2, the characteristic attributes of class Sl are “multi-sided regular polygons” whereas service class Sm is a residual service class in this illustration, containing irregular polygons and circles. Each item is associated with a report class based upon the same attributes, but according to an independent set of characteristic attributes. In FIG. 2, the characteristic attribute of R1 is “triangles” and that of R2 is “squares”. By using different attributes Ai of the items and/or different rules for associating items with report classes, the apparatus can subdivide the items into multiple report classes Rl to Rn. Attributes in this example are triangles, squares, pentagons, hexagons, octagons, circles, etc.

A report class Rn is homogeneous if it contains only items with the same characteristic attributes used to differentiate a single service class, i.e., if there is just one source Sy. A report class Rn is heterogeneous if there are two or more sources Sy and Sz. In FIG. 2, report class Rn is heterogeneous because it contains both multi-sided regular polygons and other polygons. Report classes R1 and R2, in contrast, are homogeneous because they contain only regular multi-sided polygons, and thus come only from service class Sl.

Besides being associated with a service class Sy and a report class Rn, each task may also be subcategorized into any number of subsets of service class Sy. In fact, each service class Sy may subcategorize the tasks in multiple independent ways. One important way tasks are subcategorized is by period, which implies a low, medium, high, etc., amount of resource usage. For purposes of illustration, the period of a task can be represented by the size of the item representing the task. FIG. 3 shows a chart with the period varying along the abscissa and the attribute varying along the ordinate. The top row of items are small, medium, and large circles, which are items from service class Sm. The second and third rows are small, medium, and large triangles and squares, respectively, which are items from the service class Sl.

Note in FIG. 3 that the large items from service class Sl are about the same size as the medium items from service class Sm. This highlights the importance of homogeneity, for the report class Rn in FIG. 2 may include a “large octagon” that is smaller than a “medium circle”. The periods for Rn are only meaningful if the service class that defines the boundaries between them is known. When the data is aggregated into a homogeneous report class, these boundaries defined by the service class source can be utilized by the data consumer. When the data is aggregated into a heterogeneous report class, the data provider cannot meaningfully report the period totals, since the boundaries from the multiple service classes vary from one service class to the next.

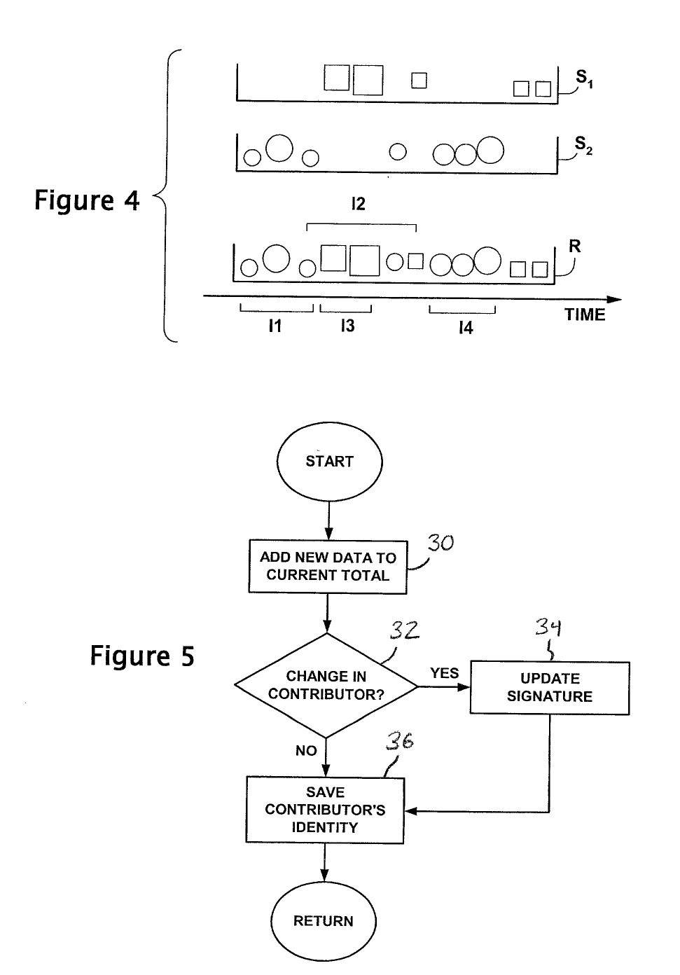

FIG. 4 shows how a single report class can be either heterogeneous or homogeneous, depending upon the interval selected. Although the individual data items (shapes) are shown for S1, S2, and R, remember that the data provider keeps only the running total and when a data consumer requests a report, it only receives the then-current values of each total. From visual inspection, one can see that at any point in time R=S1+S2. If a data consumer chooses to report on interval I2 it will find that R's data is heterogeneous, because during the interval I2 data from both S1 and S2 was accumulated into R; note that R's previous contents are irrelevant. If a data consumer chooses to report on interval I1, I3, or I4, then the data in R will be homogeneous since data accumulated during the interval came only from S2, S1, and S2, respectively.

In a system where the assignment of a particular task to a service class and report class is fixed a priori, homogeneity of the report classes can be determined statically by analyzing the rules used for these assignments. Note that such an analysis would give the incorrect result however, if not every assignment was actually made. The preferred implementation allows homogeneity to be determined based on the actual data observed, and it allows these assignments to be changed while each task executes.

The computing system herein described allows a data consumer to determine whether the data accumulated by data provider 15 to a report class R during an arbitrary interval of time was homogeneous or heterogeneous. If homogeneous, the data consumer can also determine which service class contributed the data during the interval in question.

The method and system for determining whether the accumulated data in a report class is homogeneous or heterogeneous varies depending on whether the computing system is operating in total mode or in delta mode.

Embodiment 1: Total Mode

To determine whether the report class is homogeneous or heterogeneous, the data provider provides as metadata the last known service class and a signature, which changes whenever the contributor changes. For example, the signature may be an incrementing value or a time value.

FIG. 5 shows an exemplary flow chart for maintaining this information in the data provider. This algorithm is executed each time data is to be added to the current total in R. At box 30, the new data is added to the current total and the process proceeds to box 32. Here, a determination is made as to whether the newly added data is from a different contributor than the previous data. If so, box 34 is processed, in which the signature is updated. All that is required to update the signature is that it be assigned a new, unique value. For example, the signature may be incremented, decremented or assigned the value of a timer. Using a monotone increasing function like time is a simple way to generate a unique value. After the signature is updated at box 34, the current contributor's identity is saved at box 36. If, at box 32, there is no change in contributor, then the procedure passes directly to box 36 to save the current contributor's identity, thus assuring the that identity is initialized. This procedure can be implemented using the following exemplary algorithm:

existing_totals = existing_totals +

contributor.new_data

if existing_totals.last_contributor \hat{ }=

contributor.service_class then do

existing_totals.signature = current_time

end do
existing_totals.last_contributor =

contributor.service_class

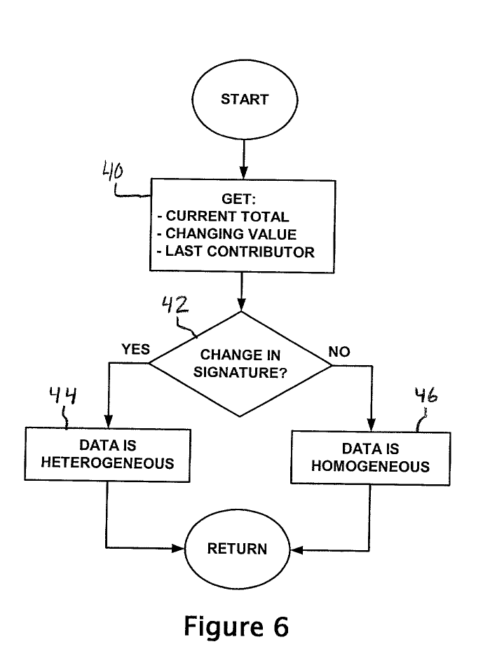

Each time the data consumer requests a report of the current totals, the data provider provides, as metadata along with the current totals, the last contributor and the signature. FIG. 6 shows an exemplary flow chart for determining, from this data, whether the signature has changed since the previous report, which would indicate that R contains heterogeneous data. Starting with box 40, the data consumer retrieves the current totals, the signature and last contributor data described above. Next, the data consumer determines at box 42 whether the signature has changed. If the signature has changed, that is an indication that the data is heterogeneous at box 44. However, if the signature has not changed, then there has been no change in the data contributor since the previous report, and the interval data is obviously homogeneous in box 46.

This method can be laid out by an exemplary algorithm as follows:

if interval_start_data.signature = _{—}

interval_end_data.signature then do

/* Data is homogeneous */
Partition_report_class =

last_contributor.partitioning_rules

end

else do

/* Data is heterogeneous */
Partition_report_class = no_rules

end

Embodiment 2: Delta Mode

When a data provider reports logical observations in delta mode, the determination of whether or not data is homogeneous is straightforward, as would be apparent to a person of ordinary skill in the art in view of the discussion above: the data provider must supply, as metadata with each logical observation, a heterogeneous/homogeneous indication and, if homogeneous, the identity of Sy. The data consumer then knows for each interval whether it has homogeneous or heterogeneous data, and can compose that knowledge into intervals of longer length. The identity Sy also tells the data consumer which subcategory thresholds were used. For the reasons previously discussed, the preferred embodiment is a system and method operating in total mode.

The system and method described above allows for determining piece-wise homogeneity of data in total mode with constant cost, i.e., any amount of data can be described by metadata consisting of the identity Sy and a signature which changes whenever the identity changes. There is no additional cost as the size of the data increases. Furthermore, in total mode, the system and method supports arbitrary intervals and invokers. There is no need for the data provider to keep track of the data consumers' identity(ies) in order to determine whether data over a given period is homogeneous. Using the <id, signature>metadata, each data consumer can have its own interval and determine the data's homogeneity itself over its interval.

The invention is preferably implemented as software (i.e., a machine-readable program of instructions tangibly embodied on a program storage device) executing on one or more hardware machines. While a particular embodiment has been shown and described, it will be apparent to those skilled in the art that other embodiments beyond the ones specifically described herein may be made or practiced without departing from the spirit of the invention. It will also be apparent to those skilled in the art that various equivalents may be substituted for elements specifically disclosed herein. Similarly, changes and/or combinations of the presently disclosed embodiments will also be apparent. The embodiments disclosed and the details thereof are intended to teach the practice of the invention and are intended to be illustrative and not limiting. Accordingly, such apparent but undisclosed changes, combinations, and modifications are considered to be within the spirit and scope of the present invention.

What is claimed is:

1. In an information handling system in which data is aggregated about work requests associated with a service class period and a report class, a method comprising:
recording metadata along with each report class period, said metadata comprising a service class name and a signature;
updating said signature each time a unit of work is aggregated into the report class and said service class changes;
comparing samples of total values taken at a beginning and end of an interval;
determining the aggregated data to be homogeneous when a signature sampled at said beginning of said interval is the same as a signature sampled at said end of said interval and determining the aggregated data to be heterogeneous when said signature sampled at said beginning of said interval is different from said signature sampled at said end of said interval.

2. The method set forth in claim 1 wherein said information handling system includes disaggregated software processes including a data provider and a data consumer, said comparing of samples performed by said data consumer and further comprising retrieving from said data provider said samples of total values and calculating said aggregated data by subtracting a beginning total from an ending total.

3. The method of claim 2, said interval being an arbitrary interval, said method further comprising directing said data consumer to select said interval independently from any processes of said data provider.

4. The method set forth in claim 2, said software processes operating in differing levels of abstraction, said data provider operating at a first level of abstraction and a data consumer operating at a second level of abstraction, said second level of abstraction being greater than said first level of abstraction.

5. The method set forth in claim 1 wherein said information handling system includes disaggregated software proceses including a data provider and a data consumer, said comparing samples and said determining being performed by said data provider, said method further comprising providing delta totals and metadata of said aggregated data to said data consumer, said metadata comprising an indication as to whether said aggregated data accumulated during said interval is homogeneous, and if so, the identity of the service class.

6. A system for handling information in which data is aggregated about work requests associated with a service class period and a report class, said information handling system comprising at least a processor carrying out machine instructions causing said system to:
record metadata along with each report class period, said metadata comprising a service class name and a signature;
update said service class name and change said signature each time a unit of work is aggregated into the report class and said service class name associated with said unit of work is different from a service class name previously recorded;
compare samples of total values taken at a beginning and end of an interval; and
determine the aggregated data to be homogeneous when a signature sampled at said beginning of said interval is the same as a signature sampled at said end of said interval and determine the aggregated data to be heterogeneous when said signature sampled at said beginning of said interval is different from said signature sampled at said end of said interval.

7. The system of claim 1 further including disaggregated software processes including a data provider and a data consumer, said instructions causing said system to compares samples being part of said data consumer process and said data consumer further causing said system to retrieve from said data provider said samples of total values and calculate said aggregated data by subtracting a beginning total from an ending total.

8. The system of claim 7, said interval being an arbitrary interval, said data consumer selecting said interval independently from any processes of said data provider.

9. The system of claim 7, said software processes operating in differing levels of abstraction, said data provider operating at a first level of abstraction and a data consumer operating at a second level of abstraction, said second level of abstraction being greater than said first level of abstraction.

10. The system of claim 6, said machine instructions including disaggregated software proceses including a data provider and a data consumer, said data provider compares said samples and said determines whether said aggregated data is homogeneous, said data provider further provides delta totals and metadata of said aggregated data to said data consumer, said metadata comprising an indication as to whether said aggregated data accumulated during said interval is homogeneous, and if so, the identity of the service class.

11. A storage medium encoded with machine-readable computer program code for managing an information handling system in which data is aggregated about work requests associated with a service class period and a report class, said storage medium including instructions for causing said system to implement a method comprising:
recording metadata along with each report class period, said metadata comprising a service class name and a signature;
updating said service class name and changing said signature each time a unit of work is aggregated into the report class and said service class name associated with said unit of work is different from the service class name previously recorded;
comparing samples of total values taken at a beginning and end of an interval;
determining the aggregated data to be homogeneous when a signature sampled at said beginning of said interval is the same as a signature sampled at said end of said interval and determining the aggregated data to be heterogeneous when said signature sampled at said beginning of said interval is different from said signature sampled at said end of said interval.

12. The storage medium of 11, said machine readable instructions including disaggregated software processes including a data provider and a data consumer, said instructions causing said comparing samples to be performed by said data consumer and said storage medium further comprises instructions causing said data consumer to retrieve from said data provider said samples of total values and calculate said aggregated data by subtracting a beginning total from an ending total.

13. The storage medium of claim 12, said interval being an arbitrary interval, said method further comprising directing said data consumer to select said interval independently from any processes of said data provider.

14. The storage medium of claim 12, said software processes operating in differing levels of abstraction, said data provider operating at a first level of abstraction and a data consumer operating at a second level of abstraction, said second level of abstraction being greater than said first level of abstraction.

15. The storage medium of claim 11, said machine readable instructions including disaggregated software proceses including a data provider and a data consumer, said instructions causing said comparing samples and said determining being performed by said data provider, said instructions causing said data provider to provide delta totals and metadata of said aggregated data to said data consumer, said metadata comprising an indication as to whether said aggregated data accumulated during said interval is homogeneous, and if so, the identity of the service class.
